(19) United States
(12) Patent Application Publication
(10) Pub. No.: US 2009/0177313 A1
(43) Pub. Date: Jul. 9, 2009

(54) PORTABLE CEMENT MIXING APPARATUS

(76) Inventors: Stephen J. Heller, Shakopee, MN (US); Joseph Kreuser, Shakopee, MN (US); James Bauer, Shakopee, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/276,044

(22) Filed: Nov. 21, 2008

Related U.S. Application Data
(60) Provisional application No. 60/991,116, filed on Nov. 29, 2007.

(51) Int. Cl. G05B 21/02; B28C 7/04; B28C 7/06; B28C 7/12; G06F 17/00; G05D 7/06

(52) U.S. Cl. 700/216; 366/18; 366/16; 700/214; 700/218; 700/230; 700/265; 700/283

(57) ABSTRACT

A portable cement mixing system uses ingredients such as cement, water and sand in predetermined quantities. A digital controller coordinates all of the operating elements of the apparatus for the entire mixing process and stores mixing programs relative to the mixing process for a variety of cements which includes the various ingredient quantities. Separate storage containers each coupled to a conveyors from the container extend to a mixer to transfer that quantity to the mixer for each cement ingredient. The conveyors are operated in sequence by the controller to load the mixer with a predetermined quantity of each of the required ingredients prior to mixing. The mixer and its contents are weighed before and during the transfer of each ingredient to precisely determine and transfer the required amount of each ingredient. After the mixer is loaded with all of the ingredients, the mixer is operated for a predetermined length of time.

### CROSS-REFERENCE TO RELATED APPLICATIONS

This is a regular application filed under 35 U.S.C. § 111(a) claiming priority, under 35 U.S.C. § 119(e) (1), of provisional application Ser. No. 60/991,116, previously filed Nov. 29, 2007 under 35 U.S.C. § 111(b).

### BACKGROUND OF THE INVENTION

The present invention is directed to transportable mixing apparatus for cement operated at the construction site.

### BRIEF DISCUSSION OF THE RELATED ART

Gypsum underlayment is a frequently-employed building and non-structural material. As know, Gypsum underlayment is typically provided to a construction site in a powdered form and is subsequently mixed with sand and water to constitute a flowable slurry. This slurry is then poured into a desired target area to uniformly occupy the target area. The slurry eventually hardens into underlayment thereby forming the desired floor.

Gypsum underlayment is a composite material made up of a filler and a binder. The binder glues the filler together to form a synthetic conglomerate. The materials typically used for the binder are cement and water, while the filler is usually fine or coarse aggregates of sand. Typically, 60-80% of the underlayment is aggregate. When sand and water are used for the ingredients an underlayment is produced.

Water is a key ingredient of underlayment. When water is mixed with gypsum a chemical process called hydration causes a paste to form that binds the aggregates together. The water to gypsum ratio is a critical factor in determining the quality of the ultimately produced underlayment. Too much water reduces underlayment strength, while too little water will make the slurry difficult to work and shape into a desired configuration. Accordingly, it is important that the appropriate water to gypsum ratio be achieved when mixing underlayment.

Different applications require different hardness of underlayment hardness. The hardness is typically varied by adjusting the concentrations of other materials, usually sand and water, relative to the concentration of gypsum in the slurry mixture. Typically, the greater the relative concentration of gypsum, the greater the resulting underlayment hardness. Underlayment hardness is typically varied between 1,000 psi to 7000 psi, with more demanding applications (e.g., areas that will experience relatively high foot traffic) requiring a harder underlayment.

It is often desirable to know with particularity the hardness that will result from a given slurry. In one respect, many installations require a specific hardness. For example, a floor intended to be covered by vinyl typically requires a hardness of 2,500 psi. In another aspect, a construction project may specify required hardness, and a fulfilling contractor may wish to deliver exactly complying underlayment so as to contain costs. However, slurry creation is a highly inexact process, with each of the ingredients typically being added in a purely guesstimated manner. Because of this inexact processes employed for creating and mixing gypsum underlayment, it is often highly difficult to produce a desired psi hardness with any degree of precision or accuracy, especially when attempted in the field.

### SUMMARY OF THE INVENTION

The use of this portable mixing apparatus is mixing the various ingredients for various types of cement as defined by a predetermined computer program in a digital controller. The mixing apparatus can either be mounted upon or be towed by a vehicle for transportation to a construction site. The controller, which has all of the capabilities of current digital computers, communicates with and controls all the various parts of the apparatus used in the mixing process. A pre-stored program in the controller determines the specific characteristics of the concrete produced.

The mixing apparatus system includes a mixer arranged to mix to together all of the elements required for a particular cement mix. The mixer has a cavity where the mixing occurs. The various ingredients are each stored individually in appropriate storage means and conveyed individually from the storage apparatus to the mixer cavity by appropriate conveyor means. The controller transfers these various ingredients from the storage means to the mixer in sequence. A weight sensing means senses the total weight of the mixer and the ingredients contained in the mixer cavity. The controller program uses the total weight of the mixer and its contents before transferring each ingredient and during the transfer of the ingredient to determine the total amount of the ingredient transferred to the mixer. The controller terminates the transfer process when the difference between the two readings indicate that the predetermined required weight for that particular ingredient has been reached.

While weight sensing is the preferred method of determining the quantity of the ingredient being transferred to the mixer, this is not intended to be limiting. Any other method of determining the quantity of the ingredient being transferred can be employed.

### BRIEF DESCRIPTION OF THE DRAWINGS

These and other features and a more thorough understanding of the present invention may be achieved by referring to the following description and claims, taken in conjunction with the accompanying drawings, wherein;

FIG. 1 is a first side view of the portable cement mixing system of the present invention mounted on a flat-bed truck;

FIG. 2 is a detailed side view, similar to FIG. 1, of the portable cement mixing system of the present invention;

FIG. 3 is a detail side view, similar to FIG. 1, of the portable cement mixing system of the present invention showing different details of the invention;

FIG. 4 is a side elevational view of the crane;

FIG. 5 is a view illustrating the cement bin and auger;

FIG. 6A is a view illustrating an end view of the sand bin;

FIG. 6B is a view illustrating a side view of the sand bin;

FIG. 7 is a view illustrating an end view of the mixer;

FIG. 8 shows the side view of the mixer;

FIG. 9 shows the mixer outlet;

FIG. 10 shows the blender outlet;

FIG. 11 shows the blender;

FIG. 12 shows the end side view of the apparatus

FIG. 13 shows a cross-section of the blender;

FIG. 14 shows an end view of the blender and scales; and

FIG. 15 shows a table.

### DETAILED DESCRIPTION OF THE INVENTION

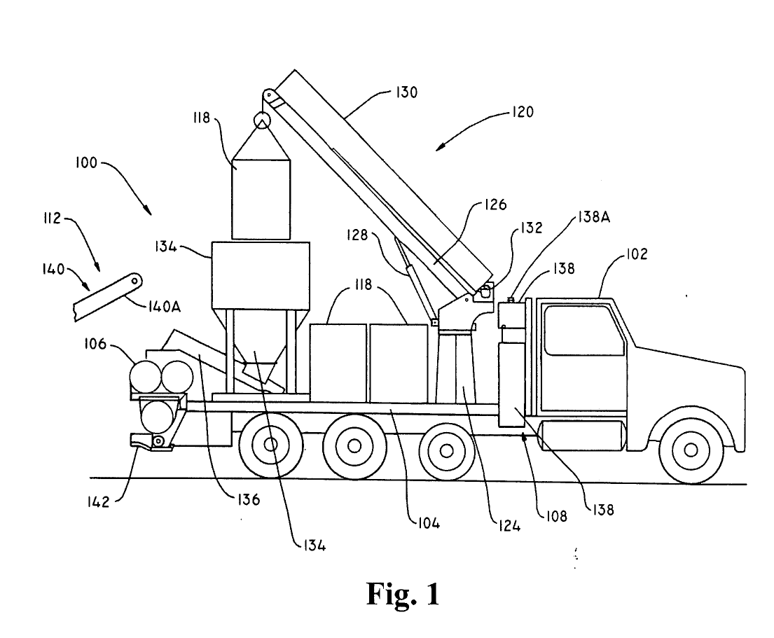

FIGS. 1, 2 and 3 show the major elements of portable cement mixing system 100 mounted on a motorized vehicle 102. This arrangement provides mobility. An alternate portable arrangement could have the cement mixing system 100 mounted upon a trailer which is towed by a truck. Either arrangement permits cement mixing system 100 to be transported to a construction site, where the cement components can be measured and mixed at the desired site.

Controller 116 provides the components and capabilities of current general-purpose computers including keyboard 116A, display 116B and a printer 116C. A keyboard 116A permits the operator to enter a variety of inputs to the apparatus in the field. Display 116B permits the operator to observe the various operating parameters and printer 116C permits generating a permanent record of selected results during the operation of the apparatus.

Keyboard 116A can be used to input such parameters as cement mixing requirements or other data. The data can relate to the hardness of the concrete, the weights of the various ingredients or any other parameter. Controller 116 is linked with, and individually controls, all operations of the apparatus. Ingredient conveyors are operated in sequence.

Controller 116 orchestrates the operation of the entire system in response to its stored program and to various measured information. This information permits controller 116 to precisely control the apparatus and also permits avoiding potential problems in the operation of the system, described hereinafter.

The system operation can be initiated either manually by keyboard or by calling up a previously prepared and entered program, either of which provides data to controller 116 giving the desired concrete characteristic requirements. This includes the amounts of the various ingredients for the specified concrete characteristic.

The primary mode of operation of controller 116 prestores the controller with various cement formulae and related ingredient weights. These various formulae can be selected by the operator in the field by relatively simple keyboard entries. An alternate mode of operation permits the operator to change any or all of the above parameters in the field relating to different formulae by keyboard entries using interface 116A. While more time consuming, this has the advantage of permitting mixing system 100 to be used for any operation within its operating range regardless of previously prestored data. This addition provides maximum flexibility in the field.

Controller 116 interprets this data using the active program to determine the amount of weight of cement needed for each ingredient to achieve the desired concrete characteristics. In another approach, controller 116 can simply re-zero the scale reading before each transfer. Using this approach the total will then indicate only the weight of the currently transferred ingredient and will be interpreted in that manner. Mixer 106 mixes the various ingredients in the mixer for the predetermined period of time given by the program.

All of the ingredients are mixed together in mixer 106, described below. In one method, the quantity of each ingredient is determined by weighing mixer 106 immediately before and while the ingredient is conveyed to the mixer. Determining the weight of mixer 106 and its contents before the new ingredient is added and then subtracting their weight during the transfer will determine the amount of the ingredient that has been transferred. When the required weight of a given ingredient has been added, controller 116 stops that particular conveyor from conveying any more of that particular ingredient to mixer 106. When the last ingredient has been added to mixer 106, controller 116 directs mixer 106 to initiate mixing. After the predetermined mixing time has elapsed, controller 116 stops the operation of mixer 106.

Mixing system 100 can also be configured to perform a number of other complementary activities. As examples, a signal could be provided to indicate the completion of mixing to the operator. This signal could include an audible signal, or a visual sign such as a light turning on, and similar arrangements. These are representative of the variety possible other responses.

Controller 116 enables interfacing with all operating elements and precisely regulates the amount of any given ingredient (e.g., cement, water, sand, etc.) introduced into mixing system 100 as well as the various operating times and/or conditions.

Controller 116 also monitors various parameters relating to the ongoing system status to avoid potential problems. This includes such things as monitoring the quantity of cement in a blender 108, described later. Mixer 106 transfers mixed concrete from mixer 106 to blender 108 for further blending. Weight measuring means, described later, determines the weight of blender 108 and its contents to both avoid overfilling or to provide a batch of predetermined weight cement to the site.

Controller 116, which coordinates the operation of all of the system elements, is a data processing device having all of the capability of current digital computers. Appropriate connections between controller 116 and all of the described apparatus tie the entire mixing system 100 together to permit controlling the various operations of the system.

Vehicle 102 has a bed 104 which securely mounts mixing system 100. As previously discussed, mixing system 100 may also be mounted upon a trailer and towed to the site by a motorized vehicle.

Various conveyors deliver the different concrete ingredients together. The ingredients usually include cement, water and sand. The conveyors deliver the ingredients in the proper quantities to mixer 106 where they are mixed together. Controller 116 enables interfacing with, and controls the operation of, mixer 106 and the various ingredient conveyors. Controller 116 controls each conveyor device sequentially and determines that the precise required quantities of each ingredient is transferred to mixer 106 as previously described.

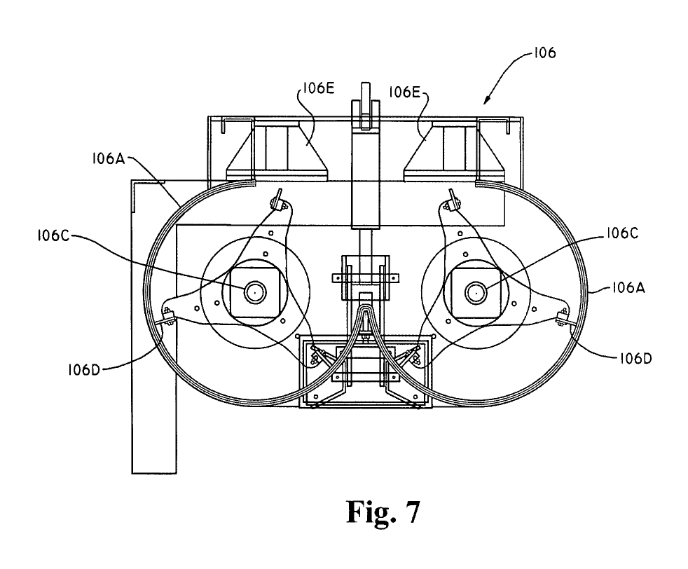

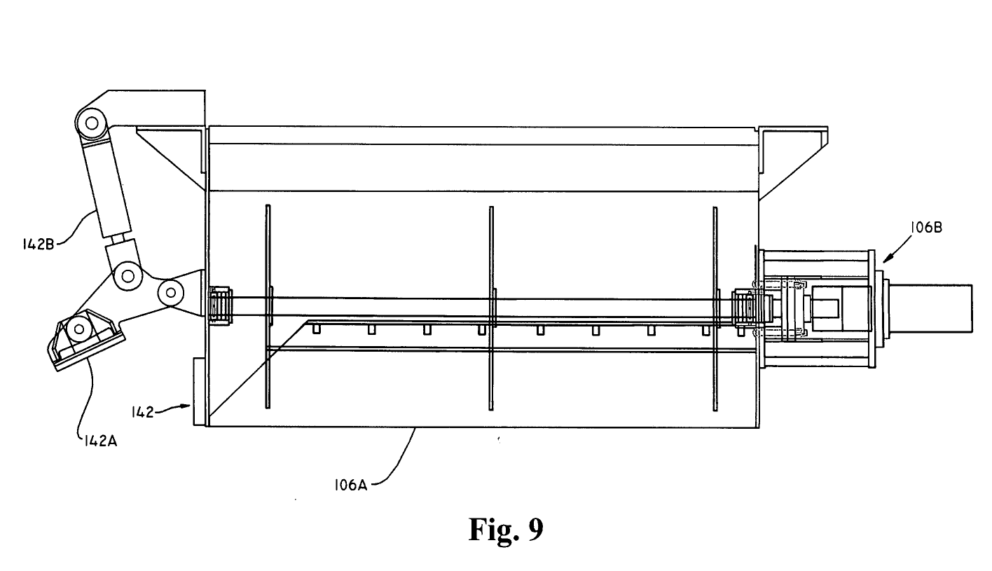

Mixer 106 is shown in FIGS. 7-9. Here various ingredients are mixed together within two interfacing cylindrically shaped segments 106A which together form a double drum housing having a 10 cubic foot capacity.

Two rotors 106C, one located within each segment 106A, are each powered by a hydraulic motor 106B attached to one end of each rotor. Each rotor 106C has three equally spaced outwardly extending paddles 106D which counter rotate relative to an adjacent rotor to completely mix any ingredients located within interfacing drum segments 106A. Interfacing drum segments 106A contain a volume of about 10 cubic feet. While motors 106B operate hydraulically using power provided by vehicle 102, other power sources and motor types can be employed.

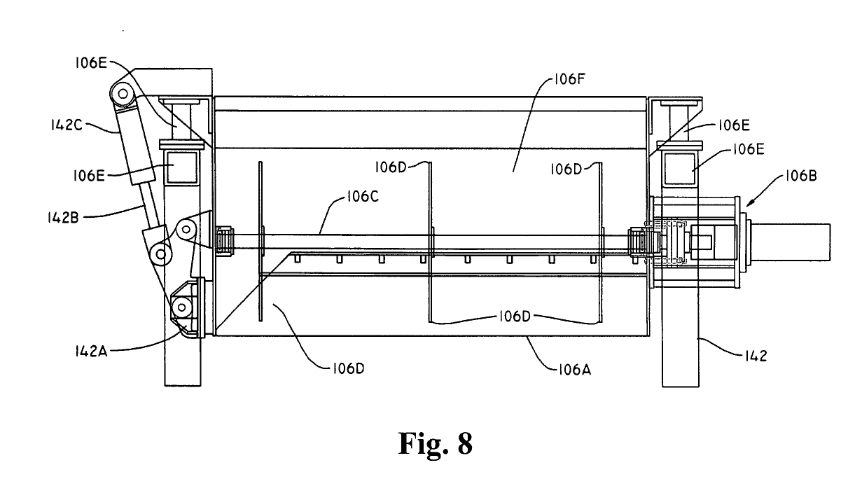

Conveyors, described hereinafter, introduce their respective ingredients into the open top of mixer 106. FIG. 8 shows two supporting scales 106E located at opposite ends of mixer 106. With this arrangement, scales 106E provide weight sensing means for measuring the weight of mixer 106 and any ingredients within segments 106A. Scales 106E send their outputs to controller 116 which in turn controls the various ingredient conveyor devices as described hereinafter. When controller 116 determines that the required weight of an ingredient has been added to the mixer 106, the program stops auger 136A.

After the mixing process is complete the mixture is dispersed through mixer outlet 142. Cover 142A is sized and arranged to close outlet 142. Apparatus 142B is arranged to move cover 142A from a position wherein mixer outlet 142 is closed to a position wherein the outlet is open. This is accomplished using hydraulic cylinder 142C. Outlet 142 is on the low side of mixer 106, thereby permitting gravity to feed the pourable concrete from mixer 106 into the outlet.

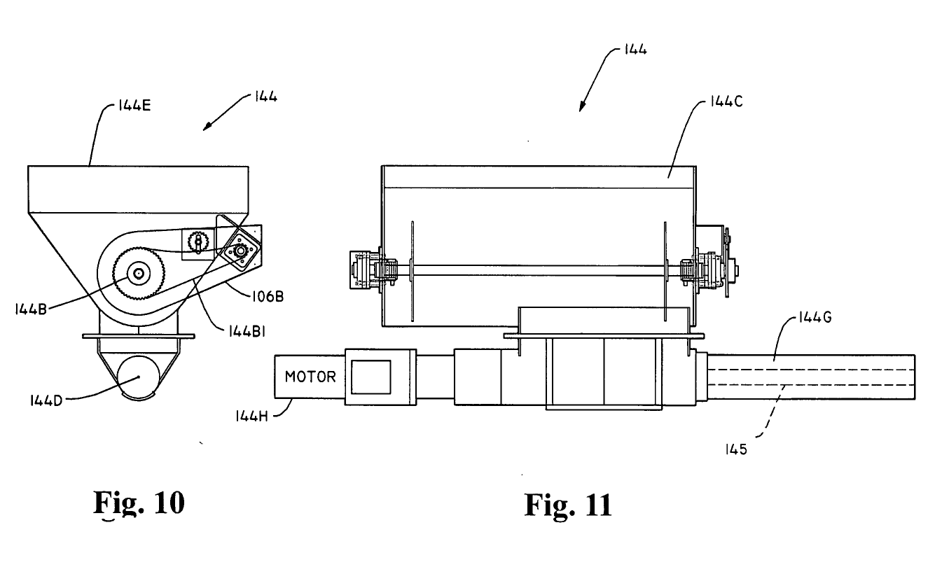

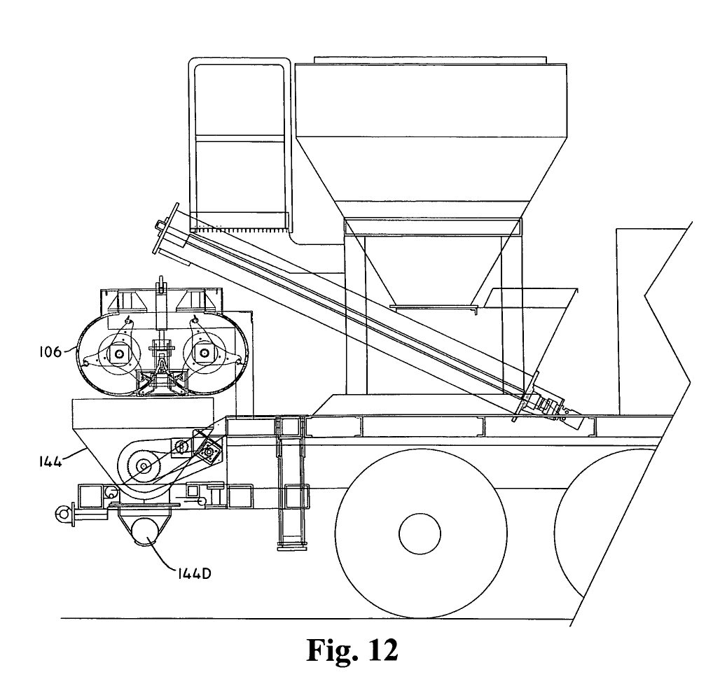

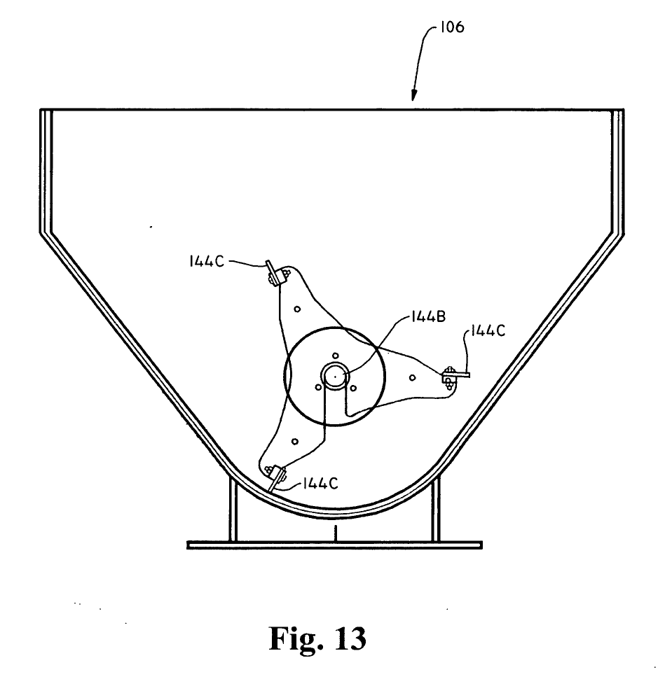

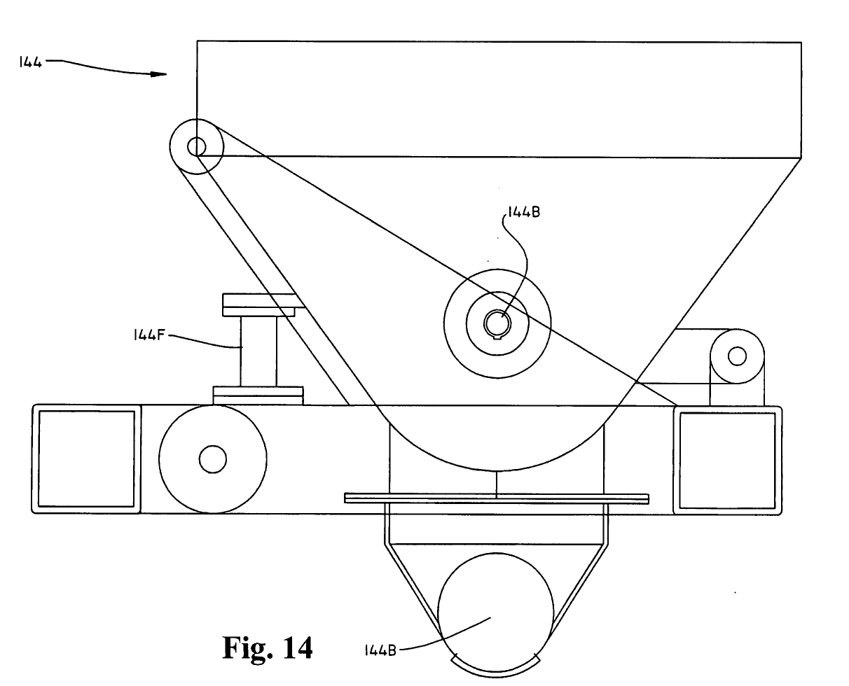

Blender 144 is shown in FIGS. 10-14. Blender 144 receives the mixture flow from mixture outlet 142 into upper opening 144E. Blender 144 has a hydraulic motor 144A with stator 145 which drives a shaft 144B by chain 144B1 to rotate paddles 144C to further blend the cement mixture. The blended cement exits through outlet 144D propelled by motor 144H driving a pump 144G which delivers the cement to the site. A scale 144F is arranged to determine the weight of blender 144 and its contents.

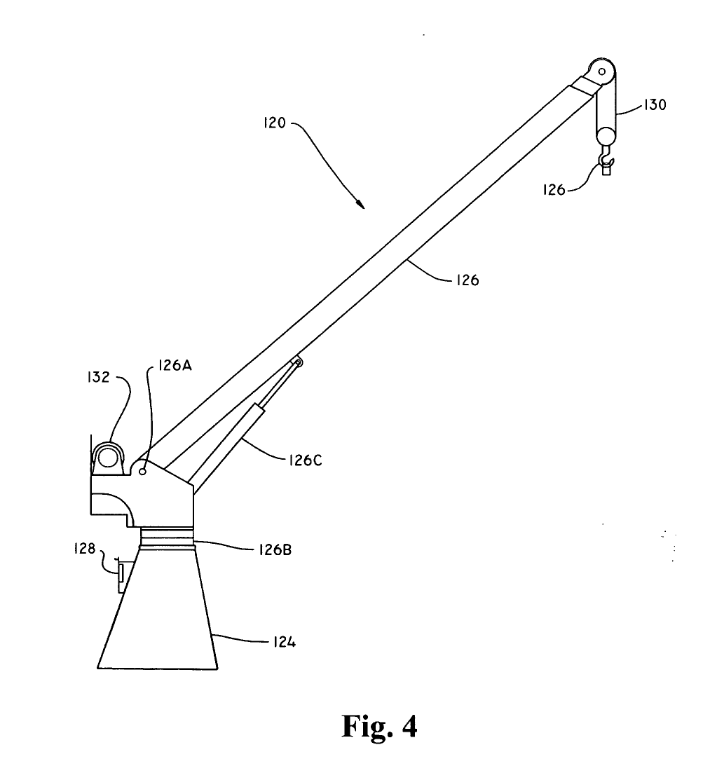

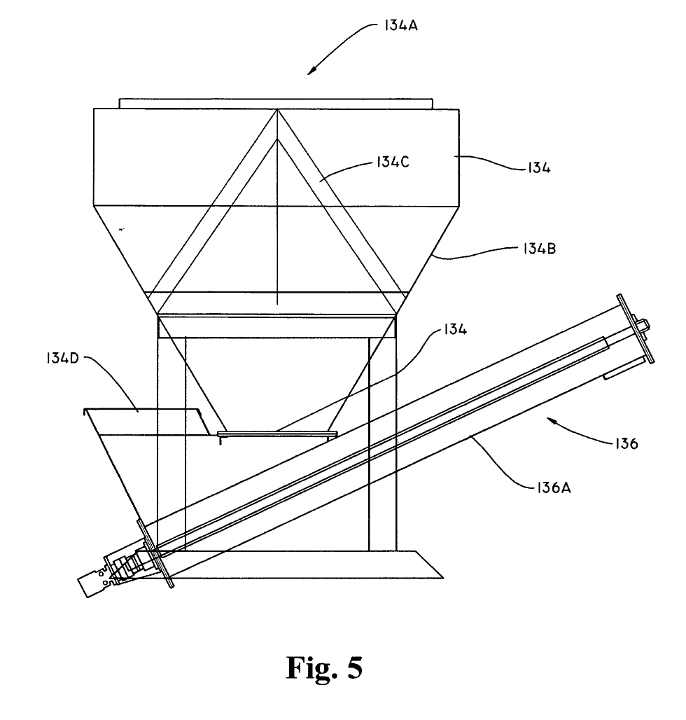

Cement conveyor device 110, shown in FIGS. 4 and 5, conveys the process of transferring cement bags 118 from a location on bed 104 of vehicle 102 to mixer 106 prior to operating the apparatus to load cement bin 134. Cement conveyor device 110 transports cement bags 118 from bed 104 to cement bin 134 using crane 120. Cement bags 118 are conventional cement bags, each containing a predetermined amount of mixing-ready concrete. Bags 118 are positioned on bed 104 in a location reachable by crane 120, as described hereinafter.

As described hereinbefore, cement bin 134 is pre-loaded with bags 118 located on bed 104 using crane 120 before operating mixing system 100. Crane 120 has a base 124, a boom 126 and a two axis boom controller 128. The functions of crane 120 can be performed, for example, by the Auto Crane, model 8406H telescoping crane.

Boom 126 can be inclined to different angles around generally horizontally oriented pivot axis 126A by hydraulically powered cylinder 126C and rotated hydraulically by rotating mount 126B under manual control using two axis controller 128. Hydraulic pressure can be provided by motorized vehicle 102. The degree of pivot of boom 126 changes the distances that the object being transported by crane 120 can travel. These two degrees of freedom of movement of the boom 126 with respect to bed 104 permits the boom to transfer cement bags 118 both on or off bed 104 of vehicle 102 to cement bin 134.

While the work as illustrated here is performed by hydraulic pressure, any other operating means capable of providing the desired result of two axis movement of boom 126 while supporting a cement bag 118 can be used.

Crane 120 has a line 130 which suspends concrete bags 118. Line 130 may be rope, metal wire, polymeric fibers, or any other material capable of extending from the boom 126 and securing a bag 118 and having the necessary strength to support the bag. A proximal end of line 130 opposite bag 118 is wound about a spool 132 to permit extension or retraction of the line 130. An additional control valve is provided to govern this extension of line 130. The opposite, distal end of line 130 terminates in hook 126C. Any other arrangement that can readily capture a concrete bag 118, however, can be used. Cement bin 134, shown in FIG. 5, can have a capacity of 70 cubic feet. Cement bin 134 has a rectangular upper opening 134A, and the cross-rotational area is gradually reduced downwardly along tapered portion 134B. Upward opening 134A is located and oriented to receive the contents of a cement bag 118 transported by boom 126. When a bag 118, positioned above upward opening 134A, is released, it falls through the opening 134A where the bag is cut open by upwardly directed V-shaped knife 134C. This releases the contents of bag 118 and allows them to fall into cement bin 134.

Cement bin 134 works in conjunction with a cement conveyor 136 to transfer cement from the cement bin to mixer 106. Conveyor 136 is shown as having a rotating auger 136A which effects the transfer of the cement from bin 134 to mixer 106. Auger 136A can be powered hydraulically and can be driven by power from vehicle 102.

Controller 116 governs the operation of auger 136A in using scales 106E on mixer 106, as described hereinbefore, to ensure that the required amount of cement is conveyed to mixer 106. While conveyor 136 is shown as utilizing an auger 136A to transfer cement, any other appropriate apparatus and power source capable of transporting cement from bin 122 to mixer 106 can be utilized.

Loading cement bags 118 can, alternatively, accomplished by positioning into the conduit for transfer through an optional port 134D.

As shown in FIGS. 1-3 water conveyor system 108 carries water to mixer 106. Water conveyor system 108 includes a reservoir 138 with a 200 gallon capacity, for example. It is coupled to mixer 106 through pipe 118A. Cap 138A, which mates with an opening on the top of reservoir 138, provides an upper opening for filling the reservoir. A hydraulically powered water pump 108B transfers water from reservoir 138 to mixer 106 under pressure to permit filling reservoir 138.

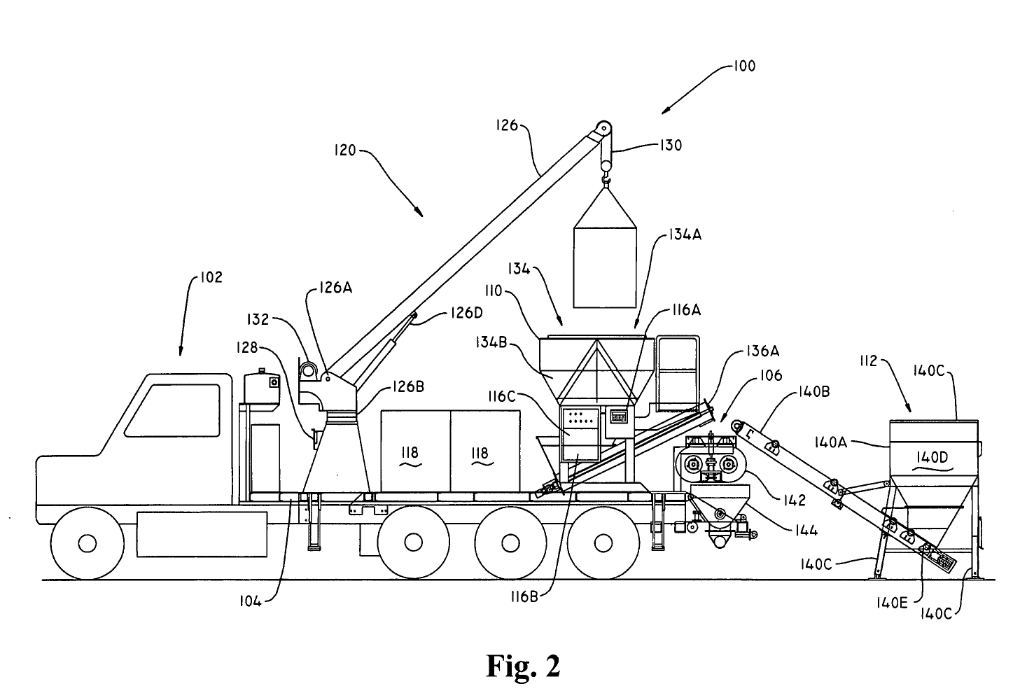

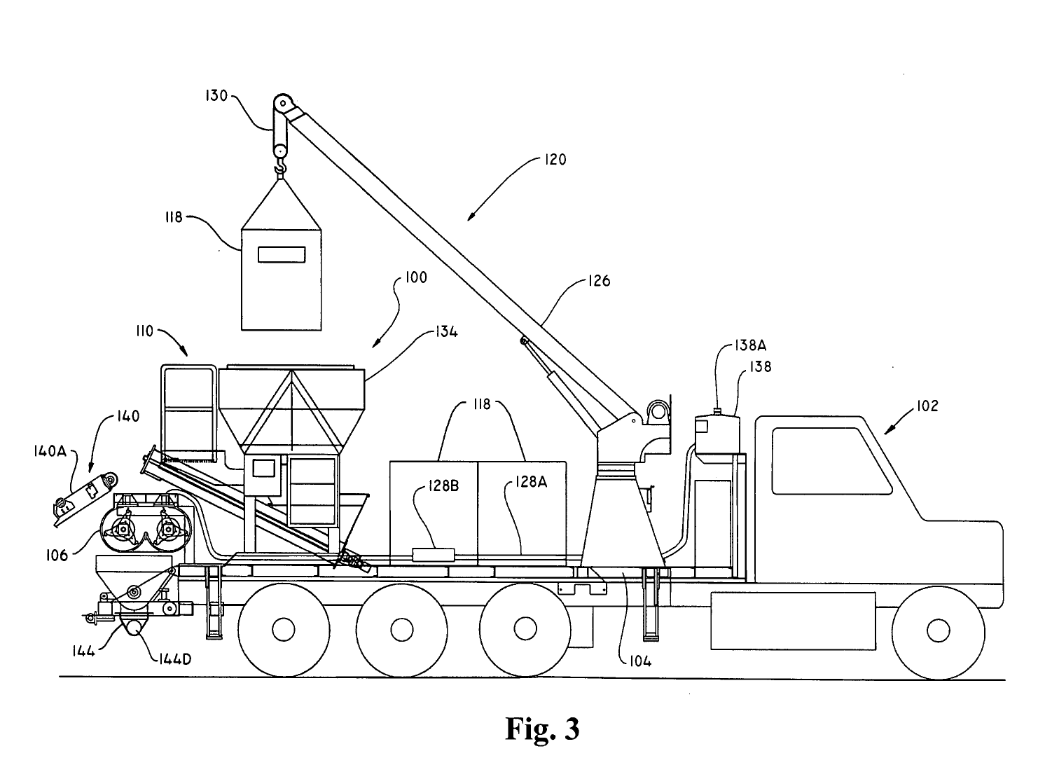

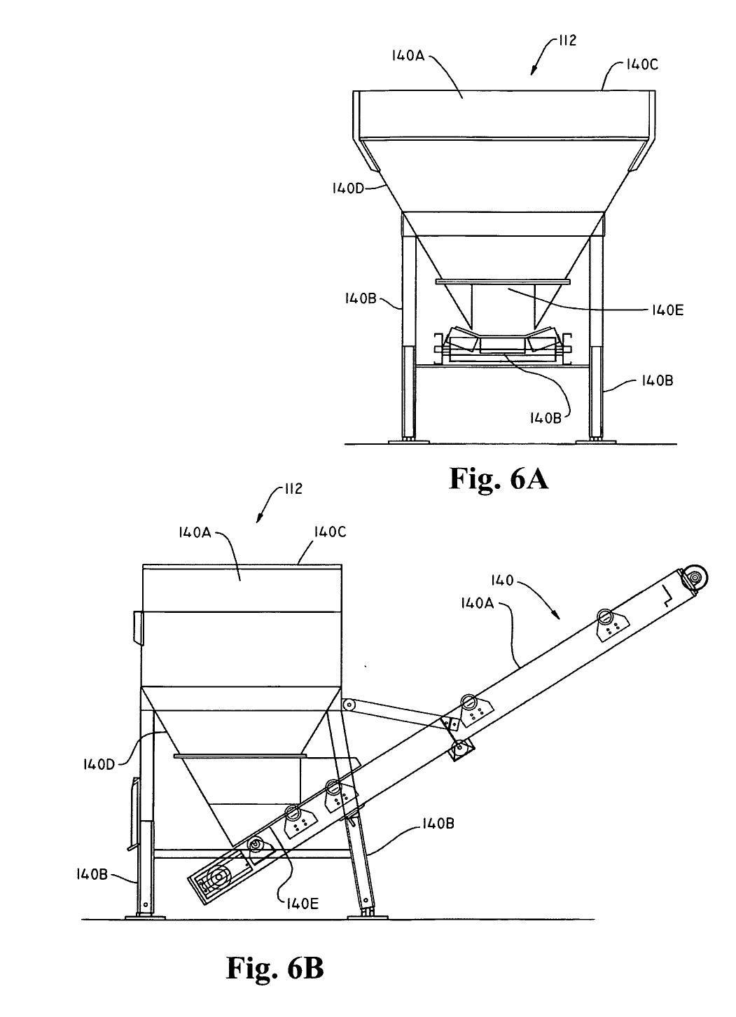

Sand conveyor system 112, shown as part of an overall system in FIGS. 2 and 3 and shown separately in FIGS. 6A and 6B, is used to transfer sand or a similar ingredient and/or filler (e.g., crushed limestone, gravel, crushed recycled concrete, or similar material) to mixer 106. Sand conveyor system 112 includes a sand bin 140A. Sand bin 140A, mounted on four legs 140B, has an optional capacity of 125 cubic feet.

Sand bin 140A has an upper opening 140C with downwardly and inwardly inclining sides and a bottom opening 140E. A conveyor arm 140 extends from below the bottom opening 140E to above upper mixer opening 106F. Conveyor belt 140B extends along the length of arm 140 from one end to the other and is driven by hydraulic motor 140F. Motor 140F drives the belt in the direction which will convey sand from below sand bin 140A to above mixer 106. The sand reservoir is shown located adjacent vehicle 102, but it could be mounted on bed 104 of vehicle 102. Sand conveyor system 112 is coupled to controller 116 in the same manner as described above for the other conveyor systems.

Mobility permits controller 116 to turn the controller motor 140F on or off as required to transfer the amount of sand required by the program and as measured by scales 106E. As described hereinbefore, controller 116 includes printer 116C. Printer 116C enables controller 116 to record all relevant parameters during system operation for the particular concrete being produced by mixing system 100. This record can include all of the above data fields and all related concrete parameters. For example, these records can including the date and selected time intervals to record the date, the water weight, the cement weight, the sand weight or any other relevant system parameters.

System 100 of the present invention can be configured to permit introduction of additional ingredients into the mixture for other products. These can include such things as fly ash, super elasticizers, retarding admixtures, accelerating admixtures, and other ingredients related to the particular product being produced.

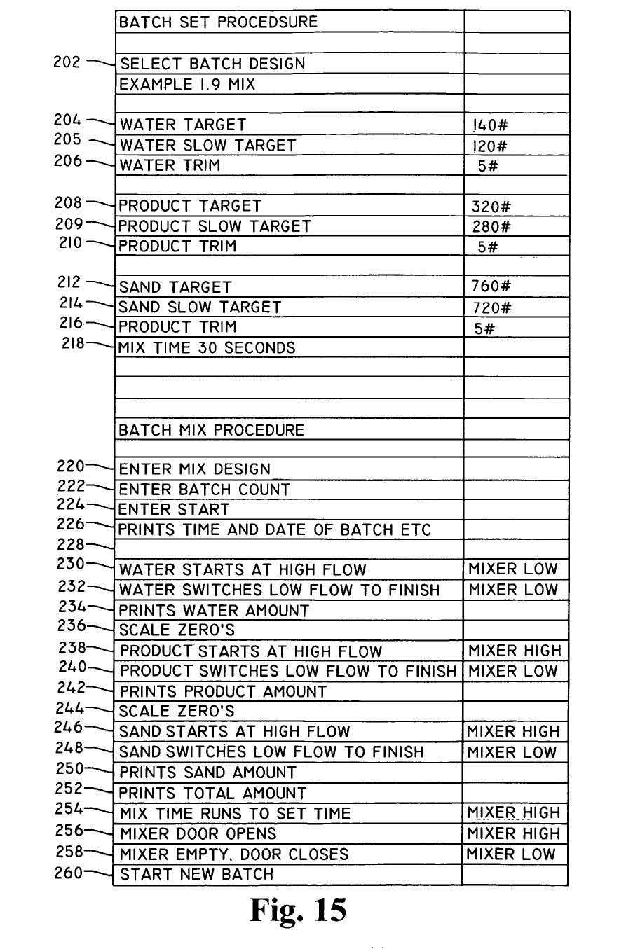

FIG. 15 is a chart which illustrates the sequence of a typical procedure for a cement mixing method in accordance with the present invention. Alternatively, the various target weights can be given. Such an alternative method essentially mirrors the procedures shown in FIG. 15.

The Batch Set Procedure begins at 202 of FIG. 15, the Select batch design step, Example 1.9 mix. In this step the user inputs desired concrete characteristics data into the system controller 116 using keyboard 116A. Controller 116 interprets this data to determine the required weight of each ingredient. In accordance with one example, the program requires that the final concrete product have a hardness of 2,500 psi. Based on such a requirement, controller 116 calculates predetermined volumes for all of the required ingredients. In the example, these ingredients are, sequentially, water, the cement product and sand. Controller 116 then converts the volumes calculated into a weight for each ingredient. An inflow rate of water is initiated based upon target weight for the initial water component. This initial flow rate is followed by a slow target rate where the ingredient is fed into the mixer at a slower rate to avoid an excessive amount being introduced. This is followed by the trim weight rate of flow necessary to achieve the final required weight. The target weight, slow target weight and trim weight are shown successively for water 140#, 120# and 5#. The flow rates for a cement product are 320#, 280# and 5#, and for sand are 760#, 720# and 5#.

A required mix time of 30 seconds, for the example, is also determined by controller 116. These weights and mixing time are merely by way of example and are different for other types of concrete.

Batch Mix Procedure begins at an Enter mix design step. Prior to this procedure, a cement bin 134 has been loaded with cement typically by using crane 120 which has been employed to transfer cement bags 118 from bed 104 to cement bin 134. Bags 118 are automatically opened by knife 124C. Sand bin 140B has also been loaded with sand. Sand conveyor system 112 has been positioned as shown in FIGS. 1-3. Water reservoir 138 has been filled with water prior to initiation of water flow into the mixer 106 in accordance with step 202.

The Batch Mix Procedure begins the process. Enter mix design, and Enter batch count by controller 116 are followed by Enter start, which begins the process. The next step, Prints time and date of batch etc., is documented by printer 116C for the record. The scale zero's step subtracts any reading attributable to the mixer scales 106E in order to weigh only the added ingredient. The steps follow such that, as previously described, water starts at high flow and the mixer speed is low. The water switches to low flow until the target amount is reached, and the mixer remains at low speed. Water amount is printed using printer 116C. The scale zero's step then follows. The product starts at high flow with mixer at high speed. The following steps are then sequentially performed:

Product switches to low speed to finish with mixer low.

Product amount is printed using printer 116C.

Scale zero's.

Sand starts at high flow with mixer at high speed.

Sand switches to low flow to finish with mixer speed low.

Sand amount is printed using printer 116C.

Prints total amount of ingredients by summing the individual ingredient weights.

Mix time runs to set time with the mixer speed high.

Mixer door opens with the mixer speed high.

Mixer empty, door closes with the mixer speed low. The determination of when the mixer is empty is also determined by the mixer weight scales 106E.

Start new batch.

After cement has been conveyed to bin 122, it is then transferred to the mixer 106 by auger 136, as at step 208. After the required amount of cement has been transferred as indicated by the data from scales 106E at step 210, weight is determined by the controller 116. Until the required amount of cement has been transferred, the method 200 continues step 208 until the correct weight has been attained. Once the required amount of cement has been introduced, the method 200 continues with step 212. Water is transferred from the reservoir 138 to the mixer 106. Again, before step 214 has been performed, step 212 is continued. After the required amount of concrete has been added, step 216 is entered and sand is then added to mixer 106. Again, before step 218, step 216 is continued until the required amount of sand has been added. Once the required amount of sand has been added, mixer 106 mixes the ingredients in step 220. After mixer 106 has mixed the ingredients for a predetermined length of time, step 222 is then entered and pourable concrete is output to blender 144.

Note that the method described hereinbefore is merely representative of one way of programming controller 116. Depending upon the particular type of cement, the ingredients required, the various mixing times, the method of determining the quantity of the ingredient being transferred and the specific hardness, different programs could be employed. The ability of controller 116 to coordinate an essentially unlimited variety of requirements quickly and accurately by merely using a different program gives this apparatus great flexibility.

Keyboard 116A is provided, as shown, as an operator interface to permit the entry of pertinent information in the field. This could be supplemented by a touch screen or a specialized interface that permits input of only certain data fields such as concrete hardness, concrete quantity and volume, and other related parameters.

In addition to providing portability, this system also provides accurate control over the quantity of the various ingredients providing for concrete hardness and the operating times of critical functions. This obviates a lack of precision and different concrete hardnesses with current mixing apparatuses.

The apparatus described hereinbefore provides a precise means of producing cement on site using an minimum amount of time. It will be understood that some steps and/or equipments could be eliminated in producing cement on site, but with less precision and with more time being required.

Although the invention has been described with regard to certain preferred example embodiments, it is to be understood that the present disclosure has been made by way of example only, and that the above simplifications and all other improvements, changes, modifications, details of construction, combination and arrangement of parts, control means and program steps may be resorted to without departing from the spirit and scope of the invention. Such simplifications, improvements, changes, and modifications within the skill of the art are intended to be covered by the scope of the appended claims.

What is claimed is:

1. Material positioning apparatus, comprising:
a) mobile means for receiving a plurality of conveyable liquid and/or powdered ingredients;
b) discrete means for storing each of said conveyable ingredients;
c) a plurality of means for conveying, each of said conveying means for transmitting a corresponding one of said ingredients from its respective storing means to said receiving means; and
d) means for sequentially ascertaining the quantity of each of said conveyable ingredients conveyed to said receiving means based upon the quantity of said ingredients previously conveyed.

2. Apparatus as in claim 1 further comprising means for controlling said receiving means, said conveying means and said ascertaining means.

3. Apparatus as in claim 2 wherein said controlling means includes means for manually entering the quantity of each ingredient conveyed to said receiving means, and further including program means for reading entries so entered and directing the conveying means to transmit a quantity of ingredient from a respective storage means to said receiving means and mix said ingredients together.

4. Apparatus as in claim 3 wherein said controlling means includes program storage means for implementing a predetermined program to provide predetermined quantities of each ingredient as parameters which will read said entries, and has means for commanding said conveying means to transmit said entered quantities of each ingredient from each respective storage means to said receiving means which, thereafter, mixes the ingredients together.

5. Transportable mixing apparatus, comprising:
a) means for mixing a plurality of ingredients to form a combination of at least one liquid ingredient and at least one conveyable granular ingredient;
b) individual storage means for storing each liquid and each conveyable granular ingredient;
c) a plurality of conveyor means for conveying each liquid and each conveyable granular ingredient from its respective individual storage means to said mixing means; and
d) means for determining the individual quantity of each liquid ingredient and each granular ingredient conveyed to said mixing means.

6. Apparatus as in claim 5 further comprising means for controlling and coordinating all elements of the mixing apparatus, said controlling means having full computer capability.

7. Apparatus as in claim 6 wherein said controlling means has manual means for manually entering data.

8. Apparatus as in claim 7 further comprising means arranged to blend the output from said mixing means.

9. Apparatus as in claim 8 wherein said determining means comprises scale means for weighing said mixing means and its contents.

10. Apparatus as in claim 9 wherein:
a) at least one liquid ingredient is water;
b) at least one storage means is a water receptacle; and wherein
c) a conveyor means for water comprises:
i) a tubular structure extending between the water receptacle and said mixing means;
ii) pump means for pressurizing the water flow; and
iii) valve means for controlling the water flow rate, with said controller being arranged to control said valve means.

11. Apparatus as in claim 10 wherein:
a) at least one granular ingredient is sand;
b) at least one storage means comprises a sand bin; and wherein
c) the sand conveyor means comprises:
i) the sand bin positioned a predetermined distance from said mixing means with said bin having an elevated tapered cross-section larger at the top than at the bottom, and having an opening at the bottom offset from a sand bin support with the opening having closure means arranged to be closed or opened by said controller means.

12. Apparatus as in claim 11 wherein;
a) another solid ingredient is cement; and wherein
b) said storage means for said cement includes bags of a predetermined size positioned on a truck bed adjacent to said mixing means.

13. Apparatus as in claim 9 wherein said conveyor means for said water comprises a tubular structure extending between said water storage receptacle, pump means for pressurizing the water flow, and valve means for controlling the water flow rate, said controller arranged to control said valve means.

14. Apparatus as in claim 11 wherein said conveyor means for said sand comprises a sand bin positioned a predetermined distance from said mixing means, said bin having a tapered cross-section larger at a top than at a bottom and having an opening at the bottom offset from the sand bin support.
